(19) United States
(12) Patent Application Publication
(10) Pub. No.: US 2026/0029851 A1
(43) Pub. Date: Jan. 29, 2026

(54) ILLUSIONARY FORCE SENSE PRESENTATION APPARATUS

(71) Applicant: Murata Manufacturing Co., Ltd., Nagaokakyo-shi (JP)

(72) Inventor: Keito KITO, Nagaokakyo-shi (JP)

(21) Appl. No.: 19/350,196

(22) Filed: Oct. 6, 2025

Related U.S. Application Data
(63) Continuation of application No. PCT/JP2024/014547, filed on Apr. 10, 2024.

(30) Foreign Application Priority Data
Apr. 14, 2023 (JP) 2023-066661

(51) Int. Cl. G06F 3/01; H02K 33/18

(52) U.S. Cl. CPC G06F 3/016; G06F 3/014; H02K 33/18

(57) ABSTRACT

An illusionary force sense presentation apparatus is provided that includes a first vibration device, a second vibration device, a third vibration device, and a controller. Each of the vibration devices includes a housing, a vibration body, and a wearing part. The first vibration device is fitted on a thumb of a user. The second vibration device and the third vibration device are fitted on any two fingers of the user other than the thumb, respectively. The controller has a mode of controlling the second vibration device and the third vibration device with the user opening a hand and a mode of controlling the first vibration device and the second vibration device with the user making a hand rounded.

### CROSS REFERENCE TO RELATED APPLICATIONS

This application is a continuation of International Application No. PCT/JP2024/014547, filed April 10, 2024, which claims priority to Japanese Patent Application No. 2023-066661, filed April 14, 2023, the contents of each of which are hereby incorporated by reference in their entireties.

### TECHNICAL FIELD

The present disclosure relates to an illusionary force sense presentation apparatus.

### BACKGROUND

For example, Japanese Unexamined Patent Application Publication No. 2020-102279 (the “’279 Application”) discloses an illusionary force sense presentation apparatus including a housing and a vibration body. The vibration body is built in the housing. A user uses the housing by grasping the housing. The vibration body vibrates in a specific pattern with the user grasping the housing, and the user thus feels an illusionary force sense based on the vibration of the vibration body. Note that such an illusionary force sense is a feeling as if the user is provided with a force moving in a specific direction by the illusionary force sense presentation apparatus.

The illusionary force sense presentation apparatus described in the ’279 Application requires the user to grasp the housing to perceive an illusionary force sense. Thus, the user has difficulty in performing another action with the hand, such as grasping an object other than the housing. As described above, the illusionary force sense presentation apparatus described in the ’279 Application restricts the movement of a hand of the user in presenting an illusionary force sense to the user.

### SUMMARY OF THE INVENTION

To address the above-described problem, one aspect of the present disclosure is an illusionary force sense presentation apparatus including: a first vibration device; a second vibration device; a third vibration device; and a controller configured to control the first vibration device, the second vibration device, and the third vibration device, in which each of the first vibration device, the second vibration device, and the third vibration device includes a housing, a vibration body accommodated in the housing and configured to generate a vibration, a wearing part coupled to the housing and fitted on a finger of a user, the first vibration device is fitted on a thumb of the user, the second vibration device and the third vibration device are fitted on any two fingers selected from an index finger, a middle finger, a ring finger, and a little finger of the user, respectively, and the controller is configured to execute a first control to cause the second vibration device and the third vibration device to present illusionary force senses of moving in the same direction with the user opening a hand, a second control to cause the second vibration device and the third vibration device to present illusionary force senses of moving in directions opposite to each other with the user opening a hand, a third control to cause the first vibration device and the second vibration device to present illusionary force senses of moving in the same direction with the user making a hand rounded, and a fourth control to cause the first vibration device and the second vibration device to present illusionary force senses of moving in directions opposite to each other with the user making a hand rounded.

According to the above-described configuration, the positional relationships and the orientations of the vibration devices are not restricted. Thus, the user can wear each of the vibration devices on any desired finger. Thus, illusionary force senses can be provided to the user with only the three vibration devices by at least the four controls, with the user being less restricted in hand movement, no matter which finger each of the vibration device is fitted on.

The user is less restricted in hand movement even when wearing each of the vibration devices of the illusionary force sense presentation apparatus on fingers.

### BRIEF DESCRIPTION OF THE DRAWINGS

In the descriptions that follow, like parts are marked throughout the specification and drawings with the same numerals, respectively. The drawings are not necessarily drawn to scale and certain drawings may be illustrated in exaggerated or generalized form in the interest of clarity and conciseness. The disclosure itself, however, as well as a mode of use, further features and advances thereof, will be understood by reference to the following detailed description of illustrative implementations of the disclosure when read in conjunction with reference to the accompanying drawings, wherein:

FIG. 1 is a schematic view of the configuration of an illusionary force sense presentation apparatus in accordance with aspects of the present disclosure;

FIG. 2 is an external view of a vibration device in accordance with aspects of the present disclosure;

FIG. 3 illustrates a state where vibration devices are fitted on a hand of a user in accordance with aspects of the present disclosure;

FIG. 4 illustrates an example of a direction of a force sense presented to an open hand in accordance with aspects of the present disclosure;

FIG. 5 illustrates an example of a direction of a force sense presented to the open hand in accordance with aspects of the present disclosure;

FIG. 6 illustrates an example of a direction of a force sense presented to the open hand in accordance with aspects of the present disclosure;

FIG. 7 illustrates an example of a direction of a force sense presented to the open hand in accordance with aspects of the present disclosure;

FIG. 8 illustrates an example of a direction of a force sense presented to a rounded hand in accordance with aspects of the present disclosure;

FIG. 9 illustrates an example of a direction of a force sense presented to the rounded hand in accordance with aspects of the present disclosure;

FIG. 10 illustrates an example of a direction of a force sense presented to the rounded hand in accordance with aspects of the present disclosure;

FIG. 11 illustrates an example of a direction of a force sense presented to the rounded hand in accordance with aspects of the present disclosure;

FIG. 12 illustrates a state where vibration devices of a modification example are fitted on a hand of the user in accordance with aspects of the present disclosure;

FIG. 13 illustrates a state where vibration devices of a modification example are fitted on a hand of the user in accordance with aspects of the present disclosure; and

FIG. 14 illustrates a state where vibration devices of a modification example are fitted on a hand of the user in accordance with aspects of the present disclosure.

### DETAILED DESCRIPTION

Hereinbelow, aspects of the present disclosure will be described. In a following description of the drawings, the same or similar components will be represented with use of the same or similar reference characters. The drawings are exemplary, sizes or shapes of portions are schematic, and technical scope of the present disclosure should not be understood with limitation to the aspects.

Hereinafter, the present disclosure of an illusionary force sense presentation apparatus will be described with reference to the figures. Note that a figure may illustrate, while enlarging, a constituent element to facilitate understanding. A dimensional ratio of a constituent element in a figure may differ from the actual one or from one in a different figure.

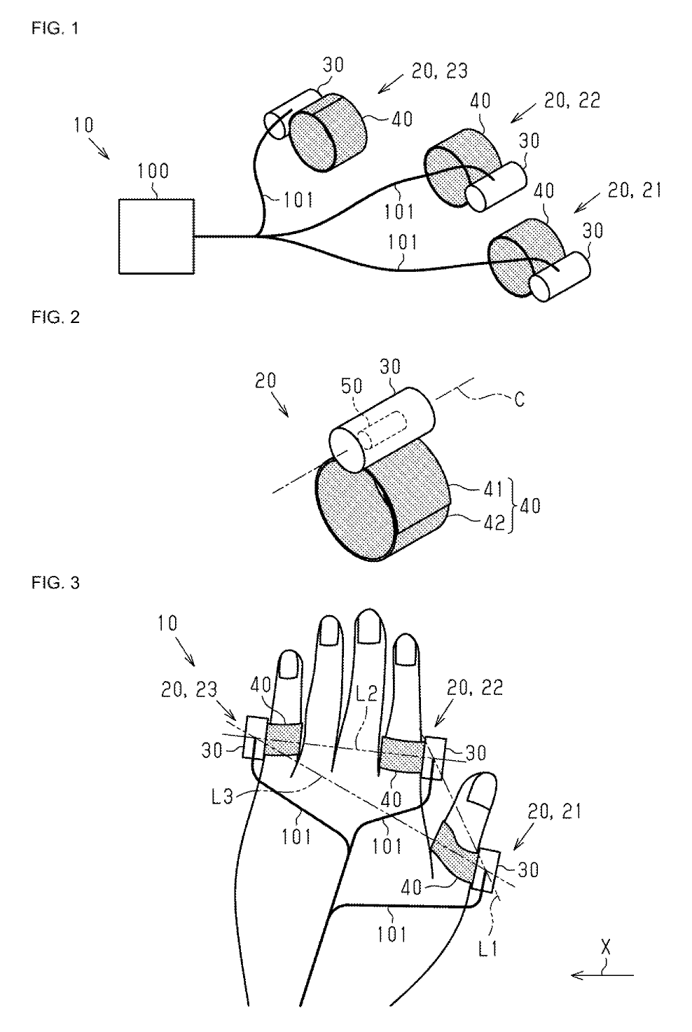

FIG. 1 illustrates, an illusionary force sense presentation apparatus 10 includes a first vibration device 21, a second vibration device 22, and a third vibration device 23. Note that, in the following description, the first vibration device 21, the second vibration device 22, and the third vibration device 23 may each simply be referred to as a vibration device 20 when there is no need to distinguish therebetween. In addition, since the three vibration devices 20 all have the same structure, one representative vibration device 20 is described below.

As FIG. 2 illustrates, the vibration device 20 includes a housing 30, a wearing part 40, and a vibration body 50.

The housing 30 has a circular columnar shape having a central axis C. The housing 30 has a hollow inside. The vibration body 50 is accommodated in the housing 30. The vibration body 50 is configured to generate a vibration. Although illustration is omitted, the vibration body 50 includes voice coil motors, a weight corresponding to each of the voice coil motors, and a cylindrical case accommodating the above-described components. The force generated with the flowing of current through a coil of the voice coil motor vibrates the weight. When the weight vibrates, the case vibrates with the vibration of the weight. Thus, the vibration body 50 is vibrated in a direction along the central axis C of the housing 30 by controlling the current that flows through the coil of the voice coil motor. In more detail, the vibration body 50 is, for example, such a vibration body described in Japanese Unexamined Patent Application Publication No. 2005-190465.

The wearing part 40 includes a first band 41 and a second band 42. The first band 41 has a strip shape and flexibility. One end of the first band 41 is coupled to an outer peripheral surface of the housing 30. The first band 41 extends in a direction orthogonal to the central axis C from the outer peripheral surface of the housing 30. That is, the width direction of the first band 41 is parallel to the central axis C of the housing 30. Although illustration is omitted, one main surface of the first band 41 is a hook-and-loop fastener.

The second band 42 has a strip shape and flexibility. One end of the second band 42 is coupled to the outer peripheral surface of the housing 30. The second band 42 extends, from the outer peripheral surface of the housing 30, in an opposite direction to the direction where the first band 41 extends. That is, as with the first band 41, the width direction of the second band 42 is parallel to the central axis C of the housing 30. Although illustration is omitted, one main surface of the second band 42 is a hook-and-loop fastener.

The wearing part 40 becomes cylindrical as a whole by sticking a hook-and-loop fastener part of the second band 42 to a hook-and-loop fastener part of the first band 41. The central axis of such a cylindrical wearing part 40 is substantially parallel to the central axis C of the housing 30. For example, by sticking the hook-and-loop fastener parts of both the bands to each other while placing the first band 41 and the second band 42 around a hand of a user, the wearing part 40 is configured to fit on a finger of the user.

As FIG. 1 illustrates, the illusionary force sense presentation apparatus 10 includes a controller 100 and three communication cables 101. The controller 100 is configured to present an illusionary force sense to the user through each of the vibration devices 20 by controlling a vibration pattern of the vibration body 50 of each of the vibration devices 20 into a specific pattern. In one aspect of the disclosure, the controller 100 stores multiple vibration patterns for presenting force senses. One of the multiple vibration patterns is a pattern for presenting a force sense of moving in one direction along the central axis C of the housing 30. Another one of the multiple vibration patterns is a pattern for presenting a force sense of moving in the other direction along the central axis C of the housing 30. Note that the details of the vibration patterns for presenting force senses of moving in specific directions are omitted since the vibration patterns are known as described in the ’279 Application and the like.

The controller 100 can be configured as circuitry including one or more processors that execute various processes according to a computer program (software). Note that the controller 100 may be configured as one or more dedicated hardware circuits, examples of which include an application specific integrated circuit (ASIC), that execute at least part of the various processes, or as a circuit including a combination thereof. The processor includes a CPU and a memory, examples of which include a RAM and a ROM. Such a memory stores program code or commands configured to cause the CPU to execute a process. The memory, that is, a computer readable medium includes any available medium accessible by an all-purpose or dedicated computer. In addition, although illustration is omitted, the controller 100 includes a battery for driving each of the vibration devices 20.

Each of the communication cables 101 may be a multiaxial cable. A first end of each of the communication cables 101 is connected to the controller 100. A second end of each of the communication cables 101 is connected to the corresponding vibration body 50. Each of the communication cables 101 electrically connects the controller 100 and the corresponding vibration body 50 to each other. That is, the controller 100 transmits a signal to each of the vibration devices 20 through the corresponding communication cable 101. In addition, the battery of the controller 100 supplies electric power to each of the vibration devices 20 through the communication cable 101.

As described above, the first vibration device 21, the second vibration device 22, and the third vibration device 23 are connected to the controller 100 through the respective communication cables 101. In an alternative aspect, the first vibration device 21, the second vibration device 22, and the third vibration device 23 are not connected to one another except through the corresponding communication cables 101. That is, there is no member directly coupling the first vibration device 21, the second vibration device 22, and the third vibration device 23 to one another.

Each of the communication cables 101 is long enough to position the controller 100 outside the range of a hand of the user. For example, each of the communication cables 101 has a length of 50 cm. Thus, the first vibration device 21 is freely changeable in position and orientation relative to the second vibration device 22 within a radius of approximately 100 cm from the second vibration device 22. Note that such a length of 100 cm described above is the length of two communication cables 101. Similarly, the second vibration device 22 is freely changeable in position and orientation relative to the third vibration device 23 within a radius of approximately 100 cm from the third vibration device 23. In addition, the third vibration device 23 is freely changeable in position and orientation relative to the first vibration device 21 within a radius of approximately 100 cm from the first vibration device 21.

An example of the aspect where the first vibration device 21, the second vibration device 22, and the third vibration device 23 are fitted on a hand of the user is described below.

As FIG. 3 illustrates, the first vibration device 21 is fitted on a thumb of the user. Specifically, the first vibration device 21 is fitted on the thumb by placing the wearing part 40 of the first vibration device 21 around a proximal phalanx part of the thumb.

The second vibration device 22 is fitted on one finger selected from an index finger, a middle finger, and a ring finger of the user. In one aspect of the disclosure, the second vibration device 22 is fitted on the index finger of the user. Specifically, the second vibration device 22 is fitted on the index finger by placing the wearing part 40 of the second vibration device 22 around a proximal phalanx part of the index finger.

The third vibration device 23 is fitted on a finger, in a middle finger, a ring finger, and a little finger of the user, on the little finger side relative to the finger wearing the second vibration device 22. In one aspect of the disclosure, the third vibration device 23 is fitted on the little finger of the user. Specifically, the third vibration device 23 is fitted on the little finger by placing the wearing part 40 of the third vibration device 23 around a proximal phalanx part of the little finger.

Here, a finger alignment direction of the hand of the user from the thumb toward the little finger is referred to as a first direction X.

With the first vibration device 21 fitted on the thumb of the user, the housing 30 of the first vibration device 21 is positioned in the opposite direction to the first direction X, from the wearing part 40 of the first vibration device 21. Note that, for the state where "the housing 30 is positioned in the opposite direction to the first direction X, from the wearing part 40", the center of gravity of the housing 30 may be positioned in the opposite direction to the first direction X, from the central axis of the cylindrical wearing part 40. That is, the entire housing 30 is not necessarily positioned in the opposite direction to the first direction X, from the entire wearing part 40. Hereinafter, the same applies to the housing 30 of the second vibration device 22 and the housing 30 of the third vibration device 23.

With the second vibration device 22 fitted on the finger of the user, the housing 30 of the second vibration device 22 is positioned in the opposite direction to the first direction X, from the wearing part 40 of the second vibration device 22. With the third vibration device 23 fitted on the finger of the user, the housing 30 of the third vibration device 23 is positioned in the first direction X from the wearing part 40 of the third vibration device 23.

In addition, as described above, the first vibration device 21 is freely changeable in position and orientation relative to the second vibration device 22 within a radius of approximately 100 cm from the second vibration device 22. Namely, with none of the vibration devices 20 fitted on fingers of the user, the first vibration device 21 is freely changeable in position and orientation relative to the second vibration device 22 within a radius of at least 25 cm from the second vibration device 22.

In addition, the second vibration device 22 is freely changeable in position and orientation relative to the third vibration device 23 within a radius of approximately 100 cm from the third vibration device 23. Namely, with none of the vibration devices 20 fitted on fingers of the user, the second vibration device 22 is freely changeable in position and orientation relative to the third vibration device 23 within a radius of at least 25 cm from the third vibration device 23.

In addition, the third vibration device 23 is freely changeable in position and orientation relative to the first vibration device 21 within a radius of approximately 100 cm from the first vibration device 21. That is, with none of the vibration devices 20 fitted on fingers of the user, the third vibration device 23 is freely changeable in position and orientation relative to the first vibration device 21 within a radius of at least 25 cm from the first vibration device 21.

Note that the length of a typical human hand when spreading from the thumb to the little finger is within approximately 25 cm. Thus, each of the vibration devices 20 is freely changeable in position and orientation within the range of one hand.

In addition, with the first vibration device 21, the second vibration device 22, and the third vibration device 23 fitted on the fingers of the user, suppose an imaginary straight line connecting two of the three vibration devices 20 is drawn. Specifically, suppose a first imaginary straight line L1 passing through the center of gravity of the housing 30 of the first vibration device 21 and the center of gravity of the housing 30 of the second vibration device 22 is drawn. The third vibration device 23 does not exist on the first imaginary straight line L1. In addition, suppose a second imaginary straight line L2 passing through the center of gravity of the housing 30 of the second vibration device 22 and the center of gravity of the housing 30 of the third vibration device 23 is drawn. The first vibration device 21 does not exist on the second imaginary straight line L2. In addition, suppose a third imaginary straight line L3 passing through the center of gravity of the housing 30 of the third vibration device 23 and the center of gravity of the housing 30 of the first vibration device 21 is drawn. The second vibration device 22 does not exist on the third imaginary straight line L3. That is, one of the first vibration device 21, the second vibration device 22, and the third vibration device 23 does not exist on the imaginary straight line connecting the other two.

The controller 100 has eight vibration modes as vibration modes of the first vibration device 21, the second vibration device 22, and the third vibration device 23. Specifically, the controller 100 has four vibration modes of not vibrating the vibration body 50 of the first vibration device 21 while vibrating the vibration body 50 of the second vibration device 22 and the vibration body 50 of the third vibration device 23. As the four vibration modes, the controller 100 has a first vibration mode, a second vibration mode, a third vibration mode, and a fourth vibration mode. The first to fourth vibration modes are preferable vibration modes to present force senses to the user with the user opening a hand.

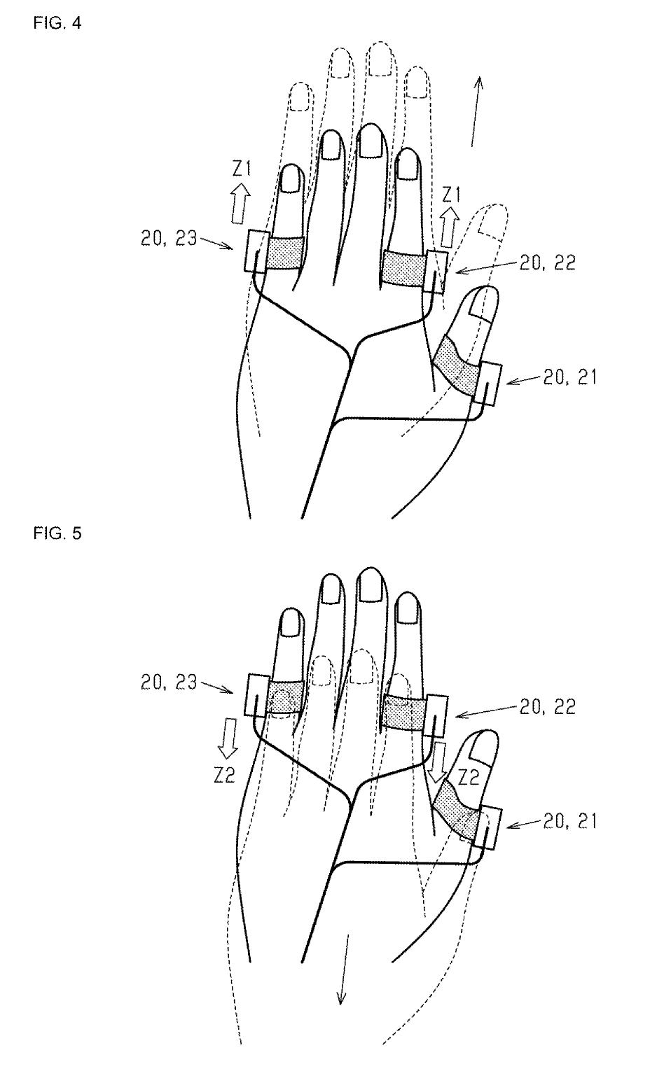

As described above, each of the vibration bodies 50 stores patterns for presenting force senses of moving in one direction and the other direction along the central axis C of the housing 30. Here, as FIGS. 4 and 5 illustrate, with each of the vibration devices 20 fitted on the corresponding finger as described above, a direction, in the directions along the central axis C, from the wrist toward a fingertip is referred to as a first positive direction Z1. In addition, with each of the vibration devices 20 fitted on the corresponding finger as described above, a direction, in the directions along the central axis C, from a fingertip toward the wrist is referred to as a first negative direction Z2. Note that the following description is given on the supposition that each of the vibration devices 20 is fitted on the left hand of the user.

As FIG. 4 illustrates, in the first vibration mode, the controller 100 causes the second vibration device 22 to present a force sense in the first positive direction Z1. In addition, in the first vibration mode, the controller 100 causes the third vibration device 23 to present a force sense in the first positive direction Z1. By controlling the directions of the force senses presented by the second vibration device 22 and the third vibration device 23 as described above, the user, while opening the hand, feels the force sense and feels like the entire hand is moving in a direction toward the fingertip side.

As FIG. 5 illustrates, in the second vibration mode, the controller 100 causes the second vibration device 22 to present a force sense in the first negative direction Z2. In addition, in the second vibration mode, the controller 100 causes the third vibration device 23 to present a force sense in the first negative direction Z2. By controlling the directions of the force senses presented by the second vibration device 22 and the third vibration device 23 as described above, the user, while opening the hand, feels the force senses and feels like the entire hand is moving in a direction toward the wrist side.

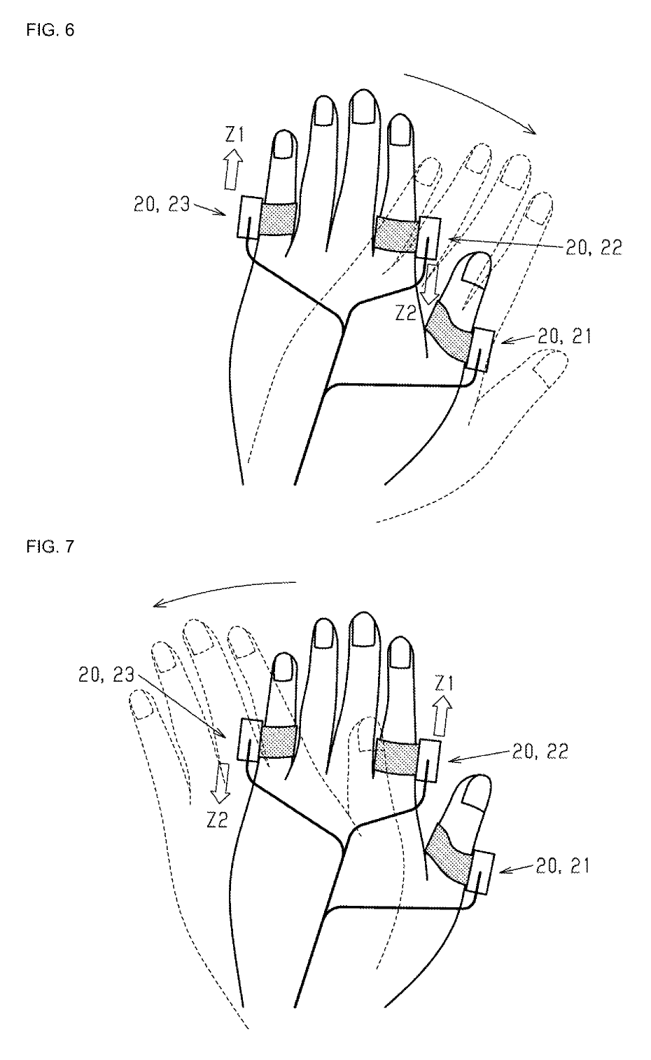

As FIG. 6 illustrates, in the third vibration mode, the controller 100 causes the second vibration device 22 to present a force sense in the first negative direction Z2. In addition, in the third vibration mode, the controller 100 causes the third vibration device 23 to present a force sense in the first positive direction Z1. By controlling the directions of the force senses presented by the second vibration device 22 and the third vibration device 23 as described above, the user, while opening the hand, feels the force senses and feels like the entire hand is rotating to the right when viewed from the back side of the hand.

As FIG. 7 illustrates, in the fourth vibration mode, the controller 100 causes the second vibration device 22 to present a force sense in the first positive direction Z1. In addition, in the fourth vibration mode, the controller 100 causes the third vibration device 23 to present a force sense in the first negative direction Z2. By controlling the directions of the force senses presented by the second vibration device 22 and the third vibration device 23 as described above, the user, while opening the hand, feels the force senses and feels like the entire hand is rotating to the left when viewed from the back side of the hand.

In addition, the controller 100 has four vibration modes of not vibrating the vibration body 50 of the third vibration device 23 while vibrating the vibration body 50 of the first vibration device 21 and the vibration body 50 of the second vibration device 22. As the four vibration modes, the controller 100 has a fifth vibration mode, a sixth vibration mode, a seventh vibration mode, and an eighth vibration mode. The fifth to eighth vibration modes are each a preferable vibration mode to present a force sense to the user with the user making a hand rounded.

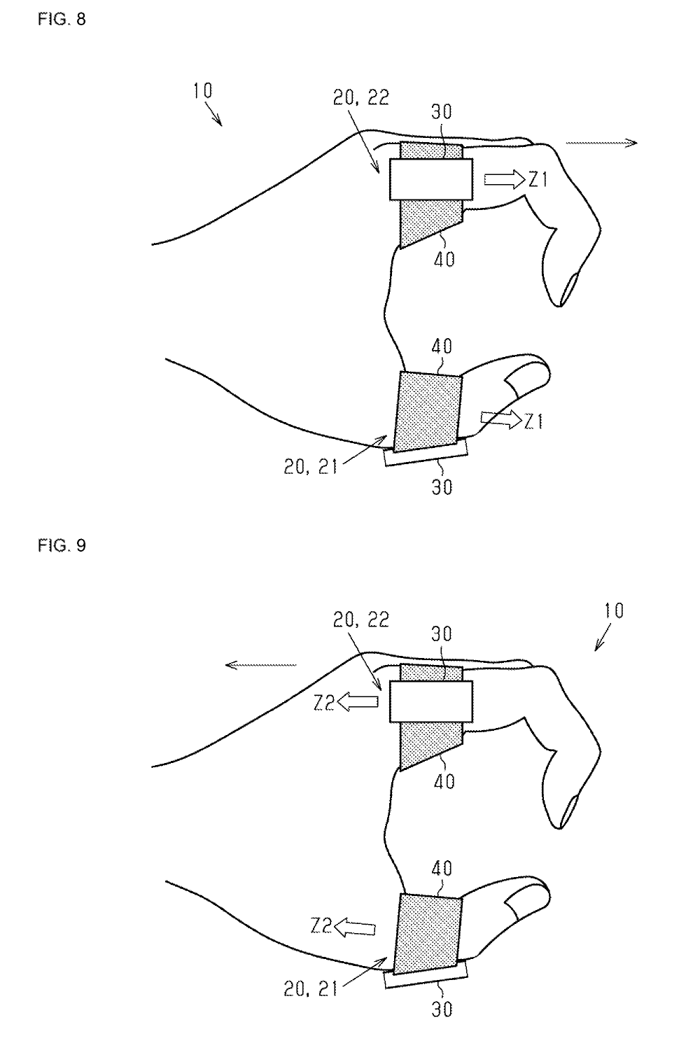

As FIG. 8 illustrates, in the fifth vibration mode, the controller 100 causes the first vibration device 21 to present a force sense in the first positive direction Z1. In addition, in the fifth vibration mode, the controller 100 causes the second vibration device 22 to present a force sense in the first positive direction Z1. By controlling the directions of the force senses presented by the first vibration device 21 and the second vibration device 22 as described above, the user, while making the hand rounded, feels the force senses and feels like the entire hand is moving in the opposite direction from the wrist.

As FIG. 9 illustrates, in the sixth vibration mode, the controller 100 causes the first vibration device 21 to present a force sense in the first negative direction Z2. In addition, in the sixth vibration mode, the controller 100 causes the second vibration device 22 to present a force sense in the first negative direction Z2. By controlling the directions of the force senses presented by the first vibration device 21 and the second vibration device 22 as described above, the user, while making the hand rounded, feels the force senses and feels like the entire hand is moving in a direction toward the wrist side.

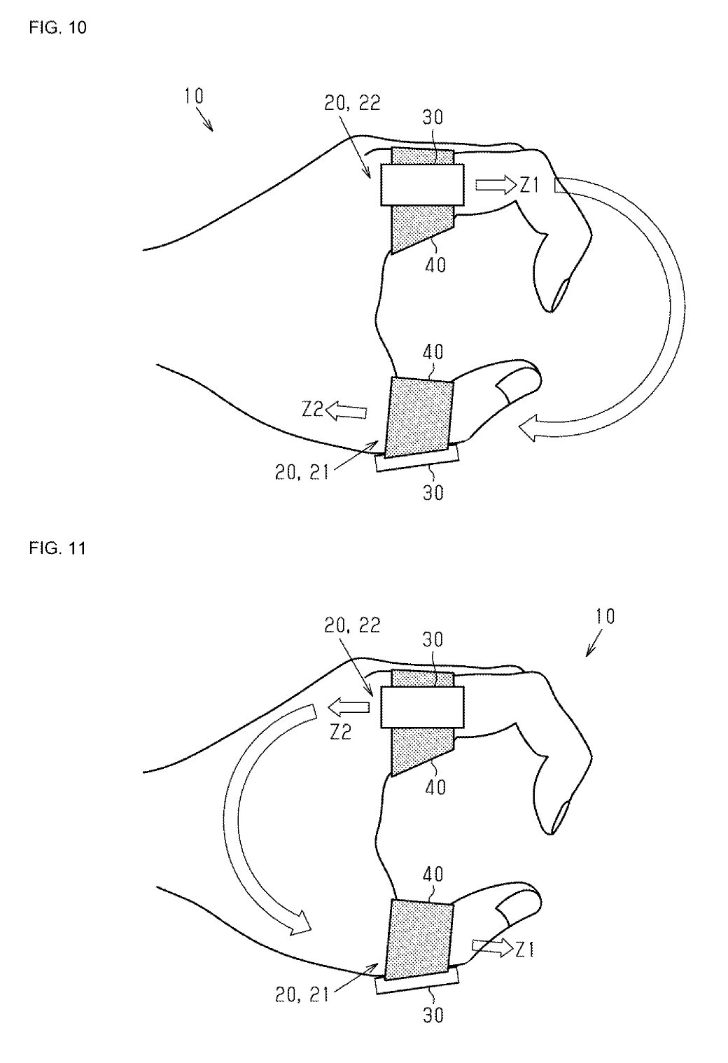

As FIG. 10 illustrates, in the seventh vibration mode, the controller 100 causes the first vibration device 21 to present a force sense in the first negative direction Z2. In addition, in the seventh vibration mode, the controller 100 causes the second vibration device 22 to present a force sense in the first positive direction Z1. By controlling the directions of the force senses presented by the first vibration device 21 and the second vibration device 22 as described above, the user, while making the hand rounded, feels the force senses and feels like the entire hand is being twisted to the right when viewed from the thumb side.

As FIG. 11 illustrates, in the eighth vibration mode, the controller 100 causes the first vibration device 21 to present a force sense in the first positive direction Z1. In addition, in the eighth vibration mode, the controller 100 causes the second vibration device 22 to present a force sense in the first negative direction Z2. By controlling the directions of the force senses presented by the first vibration device 21 and the second vibration device 22 as described above, the user, while making the hand rounded, feels the force senses and feels like the entire hand is being twisted to the left when viewed from the thumb side.

According to the above-described aspects, the vibration devices 20 are not restricted in positional relationship and orientation within a radius of 25 cm. Thus, the user can wear each of the vibration devices 20 on any desired finger. In a typical human hand, even when the fingers are spread to the maximum, the distance between the thumb and the little finger is within 25 cm at the longest. Thus, no matter which finger each of the vibration devices 20 is fitted on, the user is less restricted in hand movement.

According to the above-described aspects, since there is no restriction on which finger each of the vibration devices 20 is fitted on, instructing the user on which finger to wear each of the vibration devices 20 is possible. In addition, since the user is not restricted in hand movement, instructing the user to make a predetermined hand pose is possible. As described above, there arise variations in fingers to wear the vibration devices 20 and hand pose variations, and presenting a variety of force senses to the user is thereby possible.

According to the above-described aspects, the first vibration device 21, the second vibration device 22, and the third vibration device 23 are connected to the controller 100 through the respective communication cables 101. Thus, although only one of the vibration devices 20 may be lost, it is possible. In an alternative aspect, the first vibration device 21, the second vibration device 22, and the third vibration device 23 are not connected to one another except through the communication cables 101. According to this configuration, wearing of each of the vibration devices 20 is simplified since there is no interference of another member when each of the vibration devices 20 is fitted on a finger.

In the above-described aspects, the first vibration device 21 is fitted on a thumb of the user. In a hand, the movable direction of the thumb is different from those of the other fingers. Thus, fitting the first vibration device 21 on the thumb provides more variations in direction of a force sense that can be presented to the user.

In addition, in the above-described aspects, the second vibration device 22 is fitted on an index finger of the user. The third vibration device 23 is fitted on a little finger of the user. That is, in the above-described aspect, the vibration devices 20 are fitted on the farthest fingers from each other in the four fingers from the index finger to the little finger. This configuration makes it easier for the user to perceive a force sense with the entire hand.

In the above-described aspects, with the first vibration device 21 fitted on the finger of the user, the housing 30 of the first vibration device 21 is positioned in the opposite direction to the first direction X, from the wearing part 40 of the first vibration device 21. According to this configuration, even when the user moves the hand so as to close the space between the thumb and the index finger, the housing 30 of the first vibration device 21 is less likely to interfere with the index finger.

In the above-described aspects, with the second vibration device 22 fitted on the finger of the user, the housing 30 of the second vibration device 22 is positioned in the opposite direction to the first direction X, from the wearing part 40 of the second vibration device 22. According to this configuration, even when the user moves the hand so as to close the space between the index finger and the middle finger, the housing 30 of the second vibration device 22 is less likely to interfere with the middle finger.

In the above-described aspects, with the third vibration device 23 fitted on the finger of the user, the housing 30 of the third vibration device 23 is positioned in the first direction X from the wearing part 40 of the third vibration device 23. According to this configuration, even when the user moves the hand so as to close the space between the ring finger and the little finger, the housing 30 of the third vibration device 23 is less likely to interfere with the ring finger.

In the above-described aspects, the controller 100 has a vibration mode of not vibrating the vibration body 50 of the first vibration device 21 while vibrating the vibration body 50 of the second vibration device 22 and the vibration body 50 of the third vibration device 23. Specifically, the controller 100 has the first to fourth vibration modes. According to this configuration, the illusionary force sense presentation apparatus 10 is configured to present the open hand of the user with a force sense of moving in a direction toward the fingertip side or the wrist side. In addition, according to this configuration, the illusionary force sense presentation apparatus 10 is configured to present the open hand of the user with a force sense of being rotated in a left-right direction.

In the above-described aspects, the controller 100 has a vibration mode of not vibrating the vibration body 50 of the third vibration device 23 while vibrating the vibration body 50 of the first vibration device 21 and the vibration body 50 of the second vibration device 22. Specifically, the controller 100 has the fifth to eighth vibration modes. According to this configuration, the illusionary force sense presentation apparatus 10 is configured to present the rounded hand of the user with a force sense of moving in a direction toward the wrist side or in the opposite direction from the wrist. In addition, according to this configuration, the illusionary force sense presentation apparatus 10 is configured to present the rounded hand of the user with a force sense of being twisted. As described above, according to the above-described configuration, the user can perceive a force sense while making the hand rounded. Thus, the user can feel such above-described force senses even while grasping another member with the hand.

The above-described aspects and the following modification examples can be implemented by being mutually combined without creating contradictions.

In the above-described aspects, the shape of the housing 30 is not limited to the example of the above-described aspect. For example, the housing 30 may have a spherical shape or a rectangular parallelepiped shape. It is sufficient if the housing 30 is configured to accommodate the vibration body 50 there inside.

Although the three vibration devices 20 have the same configuration in the above-described aspect, each of the vibration devices 20 may have a different configuration. For example, the dimensions of the wearing part 40 of the first vibration device 21 may be larger than the dimensions of the wearing parts 40 of the other vibration devices 20. Thus, when the finger on which each of the vibration devices 20 is fitted is predetermined, the size, the shape, and the like of the wearing part 40 may be designed according to the size and the like of the corresponding finger.

When the finger on which each of the vibration devices 20 is fitted is predetermined, letters and a symbol indicating the finger on which the vibration device 20 is to be fitted may be provided on the housing 30 or the wearing part 40. Specifically, for example, letters such as "Thumb" may be provided on the wearing part 40 of the first vibration device 21. When such letters, a symbol, and/or the like is provided, the vibration device 20 is a "vibration device 20 to be fitted on a thumb".

In the above-described aspects, the illusionary force sense presentation apparatus 10 may further include a member connecting the three vibration devices 20 to one another. For example, the illusionary force sense presentation apparatus 10 may include a string-shaped member connecting the vibration devices 20 to one another. According to this configuration, each of the vibration devices 20 is less likely to be lost. However, a member connecting the three vibration devices 20 to one another is required to be long enough not to restrict the positional relationships and the orientation of each of the vibration devices 20 within a radius of 25 cm.

The configuration of the wearing part 40 is not limited to the configuration of the above-described aspect. For example, the wearing part 40 may be an annular member made of a material, examples of which include a synthetic resin and a metal. The wearing part 40 may be of any shape and material as long as the wearing part 40 is configured to fit on a finger of the user and transmitting the vibration of the vibration body 50 to the finger of the user.

In the above-described aspects, each of the vibration devices 20 may further include an additional vibration body configured to vibrate in a different direction from the direction where the vibration body 50 of the above-described aspect vibrates. The different direction is specifically a direction crossing the central axis C of the housing 30. For example, when the vibration device 20 further includes a vibration body configured to vibrate in a direction orthogonal to the inside part of a finger of the user, the user can also perceive a force sense and feels like the hand is moving as if fanning the hand while opening the hand.

In the above-described aspects, the configuration of the vibration body 50 is not limited to the above-described configuration. For example, the vibration body 50 may use the vibration generated by a motor or may include a piezoelectric element.

In addition to the vibration patterns configured to generate force senses, the controller 100 may vibrate the vibration body 50 in a vibration pattern of generating a sense of touch, example of which include a sense of touch of roughness and a sense of touch of unevenness. Note that such above-described senses of touch can be presented to the user by, for example, adjusting the intensity distribution of the resistance generated by the vibration body 50.

In the above-described aspects, the illusionary force sense presentation apparatus 10 does not necessarily include the communication cable 101 as long as the controller 100 is configured to transmit signals to the vibration bodies 50 by radio waves. In the current aspect, each of the vibration devices 20 may include a battery and/or the like built therein.

In the above-described aspects, the first vibration device 21 may be fitted on a finger other than the thumb. In the above-described aspect, the second vibration device 22 may be fitted on a finger other than the index finger. In the above-described aspect, the third vibration device 23 may be fitted on a finger other than the little finger. In addition, for example, the first vibration device 21, the second vibration device 22, and the third vibration device 23 may also be fitted on the same finger.

In the above-described aspects, the wearing position of each of the vibration devices 20 on a finger is not limited to the example of the above-described aspect. That is, the wearing position of the wearing part 40 of each of the vibration devices 20 is not limited to a proximal phalanx part of a finger. In addition, the wearing position may vary for each of the vibration devices 20, for example, as fitting the first vibration device 21 on a proximal phalanx part of a finger, fitting the second vibration device 22 on an intermediate phalanx part of a finger, and fitting the third vibration device 23 on a distal phalanx part of a finger.

In the above-described aspects, with each of the vibration devices 20 fitted on the finger of the user, one of the first vibration device 21, the second vibration device 22, and the third vibration device 23 may exist on the imaginary straight line connecting the other two.

In the above-described aspects, in each of the vibration devices 20, the position of the housing 30 relative to the wearing part 40 when the wearing part 40 is fitted on a finger is not limited to the example of the above-described aspect.

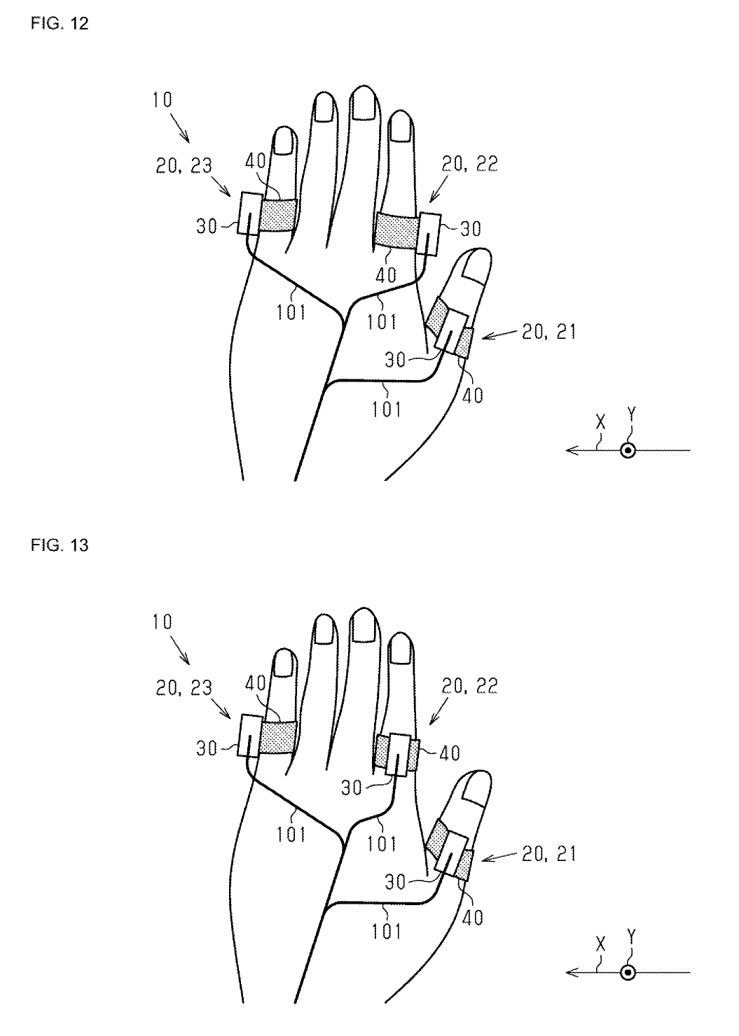

For example, as FIG. 12 illustrates, a direction from the inside part side toward the back side of a finger of the user with the user opening the hand is referred to as a second direction Y. Note that the second direction Y agrees with the direction from the palm side toward the back side of the hand of the user with the user opening the hand. Currently, with the first vibration device 21 fitted on a finger of the user, the housing 30 of the first vibration device 21 is positioned in the second direction Y from the wearing part 40 of the first vibration device 21. According to this configuration, even when the user grasps another object with the hand while wearing the first vibration device 21, the housing 30 of the first vibration device 21 is less likely to interfere with the object.

In addition, for example, as FIG. 13 illustrates, the second vibration device 22 is fitted on an index finger of the user. With the second vibration device 22 fitted on the finger of the user, the housing 30 of the second vibration device 22 is positioned in the second direction Y from the wearing part 40 of the second vibration device 22. According to this configuration, even when the user grasps another object with the hand while wearing the second vibration device 22, the housing 30 of the second vibration device 22 is less likely to interfere with the object.

In addition, in the example illustrated in FIG. 13, with the first vibration device 21 fitted on a finger of the user, the housing 30 of the first vibration device 21 is positioned in the second direction Y from the wearing part 40 of the first vibration device 21. As described above, with the vibration devices 20 fitted on the fingers of the user, in the multiple vibration devices 20, the housings 30 may be positioned in the second direction Y from the respective wearing parts 40.

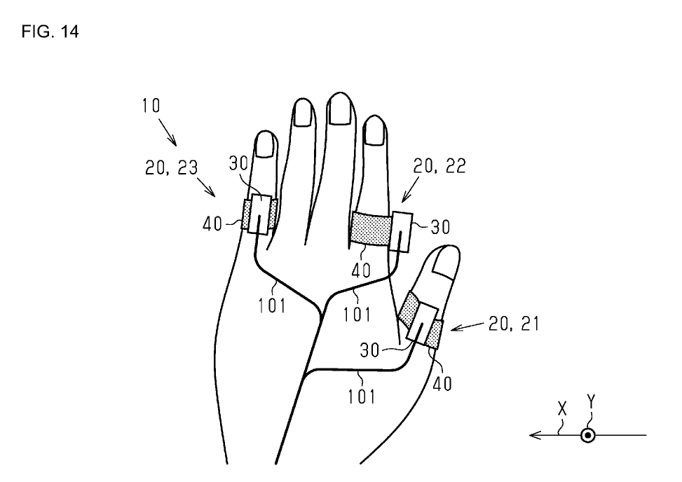

In addition, for example, as FIG. 14 illustrates, the third vibration device 23 is fitted on a little finger of the user. With the third vibration device 23 fitted on the finger of the user, the housing 30 of the third vibration device 23 is positioned in the second direction Y from the wearing part 40 of the third vibration device 23. According to this configuration, even when the user grasps another object with the hand while wearing the third vibration device 23, the housing 30 of the third vibration device 23 is less likely to interfere with the object.

In addition, depending on the purpose of use, with the vibration device 20 fitted on a finger of the user, in each of the vibration devices 20, the housing 30 may be positioned in the opposite direction to the second direction Y, from the wearing part 40. That is, the positional relationship between the housing 30 and the wearing part 40 is not limited to those in the above-described examples.

In general, the description of the aspects disclosed should be considered as being illustrative in all respects and not being restrictive. The scope of the present disclosure is shown by the claims rather than by the above description and is intended to include meanings equivalent to the claims and all changes in the scope. While preferred aspects of the invention have been described above, it is to be understood that variations and modifications will be apparent to those skilled in the art without departing from the scope and spirit of the invention.

What is claimed:

1. An illusionary force sense presentation apparatus comprising:
a first vibration device;
a second vibration device;
a third vibration device; and
a controller configured to control the first vibration device, the second vibration device, and the third vibration device,
wherein each of the first vibration device, the second vibration device, and the third vibration device includes a housing, a vibration body positioned in the housing and configured to generate a vibration, and a wearing part coupled to the housing and fitted on a finger of a user,
wherein the first vibration device is fitted on a thumb of the user,
wherein the second vibration device and the third vibration device are fitted on any two fingers selected from an index finger, a middle finger, a ring finger, and a little finger of the user, and
wherein the controller further comprises:
a first control configured to trigger the second vibration device and the third vibration device to mutually present illusionary force senses of moving in a same direction with the user opening a hand,
a second control configured to trigger the second vibration device and the third vibration device to mutually present the illusionary force senses of moving in directions opposite to each other with the user opening the hand,
a third control configured to trigger the first vibration device and the second vibration device to mutually present the illusionary force senses of moving in the same direction with the user making the hand rounded, and
a fourth control configured to trigger the first vibration device and the second vibration device to mutually present the illusionary force senses of moving in a direction opposite to each other with the user making the hand rounded.

2. The illusionary force sense presentation apparatus according to claim 1,
wherein the first vibration device is fitted on the thumb of the user,
wherein the second vibration device is fitted on one finger selected from the index finger, the middle finger, and the ring finger of the user, and
wherein the third vibration device is fitted on the finger of the middle finger, the ring finger, and the little finger of the user, on a little finger side relative to the finger wearing the second vibration device.

3. The illusionary force sense presentation apparatus according to claim 2, wherein, when a finger alignment direction of the hand of the user from the thumb toward the little finger is referred to as a first direction, with the first vibration device fitted on the finger of the user, the housing of the first vibration device is positioned in an opposite direction to the first direction, from the wearing part of the first vibration device.

4. The illusionary force sense presentation apparatus according to claim 2, wherein, when a direction from an inside part side toward a back side of the finger of the user with the user opening the hand is referred to as a second direction, with the first vibration device fitted on the finger of the user, the housing of the first vibration device is positioned in the second direction from the wearing part of the first vibration device.

5. The illusionary force sense presentation apparatus according to claim 1, wherein, when a finger alignment direction of the hand of the user from the thumb toward the little finger is referred to as a first direction, the second vibration device is fitted on the index finger of the user, and, with the second vibration device fitted on the finger of the user, the housing of the second vibration device is positioned in an opposite direction to the first direction, from the wearing part of the second vibration device.

6. The illusionary force sense presentation apparatus according to claim 1, wherein, when a direction from an inside part side toward a back side of the finger of the user with the user opening the hand is referred to as a second direction, the second vibration device is fitted on the index finger of the user, and, with the second vibration device fitted on the finger of the user, the housing of the second vibration device is positioned in the second direction from the wearing part of the second vibration device.

7. The illusionary force sense presentation apparatus according to claim 1, wherein the first vibration device is freely changeable in position and orientation relative to the second vibration device within a radius of 25 cm or more from the second vibration device, the second vibration device is freely changeable in position and orientation relative to the third vibration device within a radius of 25 cm or more from the third vibration device, and the third vibration device is freely changeable in position and orientation relative to the first vibration device within a radius of 25 cm or more from the first vibration device.

8. The illusionary force sense presentation apparatus according to claim 7, wherein the first vibration device, the second vibration device, and the third vibration device are connected to the controller through respective communication cables, and the first vibration device, the second vibration device, and the third vibration device are independent to one another except through the communication cables.

9. The illusionary force sense presentation apparatus according to claim 1, wherein, with the first vibration device, the second vibration device, and the third vibration device fitted on fingers of the user, one of the first vibration device, the second vibration device, or the third vibration device is positioned outside an imaginary straight line connecting the other two vibration devices.

10. The illusionary force sense presentation apparatus according to claim 1, wherein, when a finger alignment direction of the hand of the user from the thumb toward the little finger is referred to as a first direction, the third vibration device is fitted on the little finger of the user, and, with the third vibration device fitted on the finger of the user, the housing of the third vibration device is positioned in the first direction from the wearing part of the third vibration device.

11. The illusionary force sense presentation apparatus according to claim 1, wherein, when a direction from an inside part side toward a back side of the finger of the user with the user opening the hand is referred to as a second direction, the third vibration device is fitted on the little finger of the user, and, with the third vibration device fitted on the finger of the user, the housing of the third vibration device is positioned in the second direction from the wearing part of the third vibration device.

12. The illusionary force sense presentation apparatus according to claim 1, wherein the controller terminates the vibration body of the first vibration device in the first control and the second control.

13. The illusionary force sense presentation apparatus according to claim 1, wherein the controller terminates the vibration body of the third vibration device in the third control and the fourth control.

14. An illusionary force sense presentation system comprising:
a memory;
a processor coupled to the memory and configured to:
trigger a second vibration device and a third vibration device to mutually present illusionary force senses of moving in a same direction with a user opening a hand,
trigger the second vibration device and the third vibration device to mutually present the illusionary force senses of moving in directions opposite to each other with the user opening the hand,
trigger a first vibration device and the second vibration device to mutually present the illusionary force senses of moving in the same direction with the user making the hand rounded, and
trigger the first vibration device and the second vibration device to mutually present the illusionary force senses of moving in a direction opposite to each other with the user making the hand rounded;
wherein each of the first vibration device, the second vibration device, and the third vibration device includes a housing, a vibration body positioned in the housing and configured to generate a vibration, and a wearing part coupled to the housing and fitted on a finger of the user,
wherein the first vibration device is fitted on a thumb of the user,
wherein the second vibration device and the third vibration device are fitted on any two fingers selected from an index finger, a middle finger, a ring finger, and a little finger of the user, and
wherein the first vibration device is freely changeable in position and orientation relative to the second vibration device within a radius of 25 cm or more from the second vibration device.

15. The illusionary force sense presentation system according to claim 14, wherein the second vibration device is freely changeable in position and orientation relative to the third vibration device within a radius of 25 cm or more from the third vibration device, and the third vibration device is freely changeable in position and orientation relative to the first vibration device within a radius of 25 cm or more from the first vibration device.

16. The illusionary force sense presentation system according to claim 14, wherein, when a finger alignment direction of the hand of the user from the thumb toward the little finger is referred to as a first direction, the second vibration device is fitted on the index finger of the user, and, with the second vibration device fitted on the finger of the user, the housing of the second vibration device is positioned in an opposite direction to the first direction, from the wearing part of the second vibration device.

17. The illusionary force sense presentation system according to claim 14, wherein, with the first vibration device, the second vibration device, and the third vibration device fitted on fingers of the user, one of the first vibration device, the second vibration device, or the third vibration device is positioned outside an imaginary straight line connecting the other two vibration devices.

18. The illusionary force sense presentation system according to claim 14, wherein, when a direction from an inside part side toward a back side of the finger of the user with the user opening the hand is referred to as a second direction, the third vibration device is fitted on the little finger of the user, and, with the third vibration device fitted on the finger of the user, the housing of the third vibration device is positioned in the second direction from the wearing part of the third vibration device.

19. The illusionary force sense presentation system according to claim 14, wherein the processor terminates the vibration body of the first vibration device.

20. A method of presenting an illusionary force sense to a user, comprising:
fitting a first vibration device on a thumb of the user;
fitting a second vibration device on a first finger selected from an index finger, a middle finger, a ring finger, and a little finger of the user;
fitting a third vibration device on a second finger selected from the index finger, the middle finger, the ring finger, and the little finger of the user, the second and third vibration devices being fitted on different fingers, each of the first, second, and third vibration devices comprising:
a housing,
a vibration body accommodated in the housing, and
a wearing part coupled to the housing;
controlling, via a controller, the vibration bodies of the second and third vibration devices to vibrate according to a first vibration pattern to present the illusionary force sense of moving in a same direction with the user opening a hand;
controlling, via the controller, the vibration bodies of the second and third vibration devices to vibrate according to a second vibration pattern to present the illusionary force sense of moving in directions opposite to each other with the user opening the hand;
controlling, via the controller, the vibration bodies of the first and second vibration devices to vibrate according to a third vibration pattern to present the illusionary force sense of moving in the same direction with the user making the hand rounded; and
controlling, via the controller, the vibration bodies of the first and second vibration devices to vibrate according to a fourth vibration pattern to present the illusionary force sense of moving in the directions opposite to each other with the user making the hand rounded.
